(19) United States
(12) Patent Application Publication
(10) Pub. No.: US 2006/0023985 A1
(43) Pub. Date: Feb. 2, 2006

(54) Adaptive bearing system containing a piezoelectric actuator for controlling setting

(76) Inventors: Mircea Gradu, Wooster, OH (US); Christian Adam, Colmar (FR); Marc A. Weston, Canton, OH (US); Graham F. McDearmon, North Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/900,244

(22) Filed: Jul. 27, 2004

(51) Int. Cl. F16C 32/00; F16C 41/04; F16C 23/10

(52) U.S. Cl. 384/563

(57) ABSTRACT

The setting of opposed bearings located between two machine components is controlled with at least one piezoelectric actuator located such that it axially displaces a race of one of the bearings.

### CROSS REFERENCE TO RELATED APPLICATIONS

None.

### STATEMENT REGARDING FEDERALLY SPONSORED RESEARCH

Not Applicable.

### BACKGROUND OF THE INVENTION

This invention relates to bearings and more particularly to a bearing system containing a piezoelectric device for controlling the setting of the bearings in the system.

Tapered roller bearings and some other antifriction bearings with inclined raceways, such as angular contact ball bearings, have the capacity to transfer thrust (axial) loads as well as radial loads. When two single row bearings of this type are mounted in opposition, the bearing system so formed has the capacity to transfer or take thrust loads in both directions, and of course radial loads. Moreover, the bearings can be adjusted against each other so that the setting for the bearings can be varied between end play and preload.

When a bearing system operates with end play, clearances, both radial and axial, exist within one or both of its bearings, that is to say the rolling elements of at least one of the bearings do not seat against their raceways for the full circumferences of those raceways. This produces instability in that which rotates on the bearing or, in other words, the axis of rotation is not entirely fixed. However, wear in the bearing is minimal when the bearings are in end play.

When a bearing system operates in preload, the rolling elements of both bearings contact their raceways for the full circumferences of those raceways. This brings stability to the system. But preload increases friction and wear in the bearings, and heavy preloads can induce early failure.

Most equipment that utilizes opposed antifriction bearings operates more efficiently with the bearings set to light preload. However, in some applications, a variance in the preload or even a variance between end play and preload would seem desirable. For example, the opposed bearings that couple the road wheel of an automotive vehicle to the suspension system of the vehicle require little preload and only moderate stability when the vehicle travels straight at moderate speeds. But when the vehicle negotiates turns, particularly at high speeds, the bearing system for the wheel should have greater stability.

Many times, shafts and the bearings which support them are made from steel, while the housings which enclose them are made from aluminum. The differential thermal expansion and contraction which ensues can disrupt bearing settings. Compensating devices exist, but are not entirely satisfactory.

Also, manufacturers of equipment that utilizes rotating components supported on opposed antifriction bearings need to know the optimum setting for the bearing—a setting that will perhaps produce the least noise in gears—and to determine this with multiples setups established by shims of varying thickness is a time-consuming and imprecise procedure.

To be sure, hydraulic systems exist for varying preload—and end play—in bearings systems formed by opposed single row bearings. However, these systems react somewhat sluggishly, consume considerable space, and require complex fluid devices to vary pressure.

### BRIEF DESCRIPTION OF THE SEVERAL VIEWS OF THE DRAWINGS

FIG. 1 is a longitudinal sectional view of a shaft supported in a housing on a bearing system constructed in accordance with and embodying the present invention;

FIG. 2 is a perspective view of an actuator forming part of the bearing system;

FIG. 3 is a block diagram of a control circuit for the bearing system;

FIG. 4 is a flow chart representing a closed loop control for the actuator of the bearing system; and

FIG. 5 is a longitudinal sectional view of a rotatable hub supported on a spindle with a modified bearing system.

### DETAILED DESCRIPTION OF INVENTION

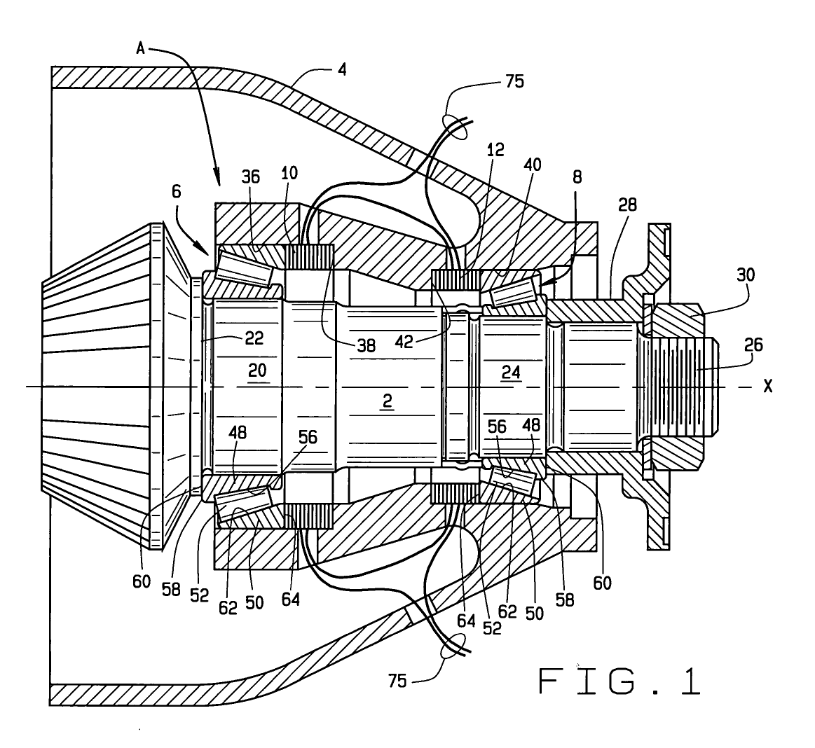

Referring now to the drawings, a bearing system A, shown in FIG. 1, supports a shaft 2 in a housing 4, so that the shaft 2 can rotate in the housing 4 about an axis X. The housing 4 may enclose the operative components of an axle differential, one of which is the shaft 2, although the bearing system A is well suited for other equipment as well, generally where one machine component rotates within another machine component. The bearing system A includes two single row tapered roller bearings 6 and 8 which are mounted in opposition between the shaft 2 and housing 4, the former being in a head position and the latter in a tail position. In addition, the bearing system A includes piezoelectric actuator assemblies 10 and 12 which control the setting of the bearings 6 and 8.

Considering the shaft 2 first, it has a bearing seat 20 which leads up to a shoulder 22 for the head bearing 6. Shaft 2 also has a smaller bearing seat 24 for the tail bearing 8 and a threaded end 26 beyond the seat 24. The shaft 2 carries a collar 28 which forms a shoulder at one end of the smaller bearing seat 24. The collar 28 is positioned with a nut 30 that threads over the threaded end 26.

The housing 4 includes a counterbore 36 which at one end opens into the interior of the housing 4 and at an opposite end leads up to a shoulder 38. The counterbore 36 contains the actuator 10 and also serves as another bearing seat for the head bearing 6. The counterbore 36 surrounds the bearing seat 20 for the shaft 2. The housing 4 also has another counterbore 40 which at one end opens out of the housing 4 and at its opposite end leads up to a shoulder 42. The counterbore 40 contains the piezoelectric actuator assembly 12 and serves as a bearing seat for the tail bearing 8. Counterbore 40 surrounds the bearing seat 24 for the shaft 2.

Each bearing 6 and 8 includes an inner race in the form of a cone 48, an outer race in the form of a cup 50, and rolling elements in the form of tapered rollers 52 organized in a single row between the cone 48 and the cup 50. The cone 48 has a tapered raceway 56 which is presented outwardly away from the axis X and a thrust rib 58 at the large end of the raceway 56. The thrust rib 58 leads out to a back face 60 that is squared off with respect to the axis X. The cup 50 has a tapered raceway 62 that is presented inwardly toward the axis X and toward the raceway 56 of the cone 48. The raceway 62 at a small end leads out to a back face 64 that is also squared off with respect to the axis X. The tapered rollers 52 lie in a row between the raceways 56 and 64, with their tapered side faces contacting the raceways 56 and 62 and their large ends bearing against the thrust rib 58 on the cone 48. Generally speaking, line contact exists between the side face of each roller 52 and the tapered raceways 56 and 62.

The thrust rib 58 prevents the rollers 52 from moving up the raceways 56 and 62 and being expelled from the annular space that they occupy between the raceways 56 and 62. The tapered rollers 52 are on apex, meaning that the conical envelopes within which their side faces lie have their apices at a common point along the axis X. Likewise, the conical envelopes in which the tapered raceways 56 and 62 lie have their apices at the same point.

The cone 48 of the head bearing 6 fits over the bearing seat 20 of the shaft 2 with an interference fit. A back face 60 of the cone 48 fits against the shoulder 22 at the end of the seat 20. The cup 50 of the head bearing 6 fits into the counterbore 36 in the housing 4 with a slightly loose fit. A back face 60 of cup 50 is presented toward, yet spaced from the shoulder 38 at the end of the counterbore 36. The rollers 52 of the head bearing 6 are disposed between the cone 48 and cup 50 of that bearing 8.

The cone 48 of the tail bearing 8 fits over the other bearing seat 24 on the shaft 2, again with an interference fit. The back face 60 of cone 48 bears against the shoulder formed by the end of the collar 28. The cup 50 of the tail bearing 8 fits into the counterbore 40 in the housing 4 with a slightly loose fit. A back face 64 of the cup 50 is presented toward, yet spaced form the shoulder 42 at the inner end of the counterbore 40. The rollers 52 for the bearing 8 reside between the cone 48 and cup 50 for the bearing.

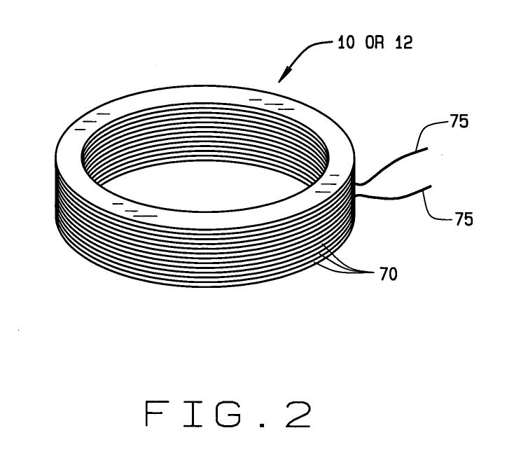

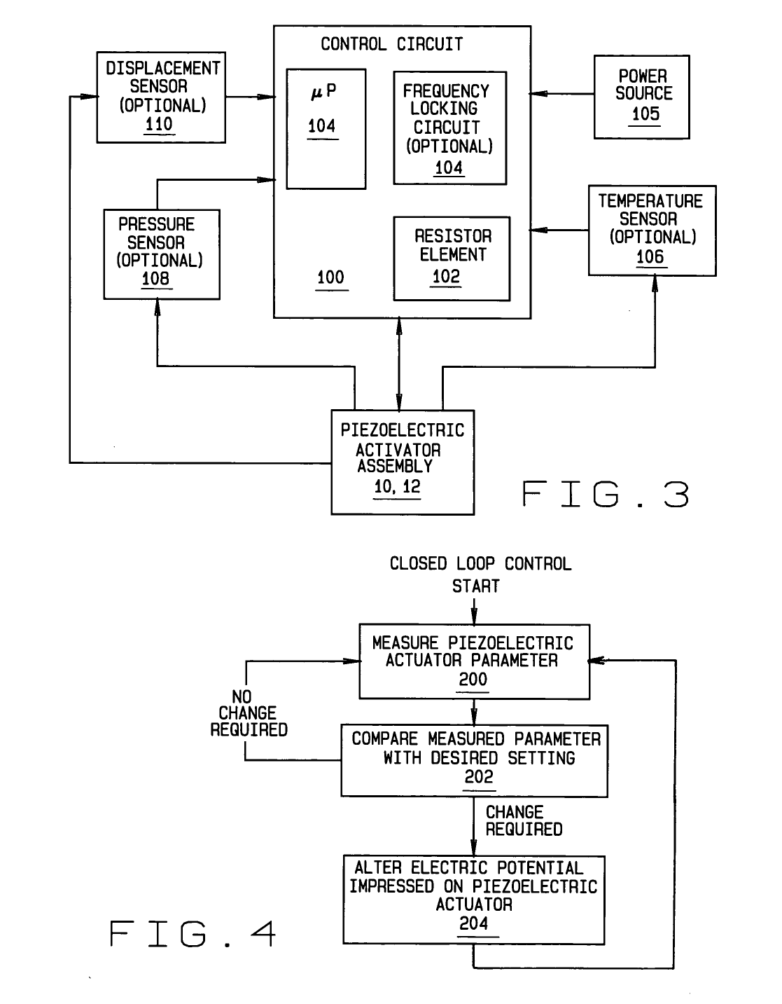

Each of the piezoelectric actuator assemblies 10 and 12 possesses an annular configuration as shown in FIG. 2. The piezoelectric actuator assembly 10 lies within the counterbore 36 of the housing 4 between the shoulder 22 at the end of that counterbore and the back face 64 of the cup 50 for the head bearing 8. The piezoelectric actuator assembly 12 lies within the other counterbore 40 between the shoulder 42 at the end of that counterbore and the back face 64 on the cup 50 of the tail bearing 8. Each piezoelectric actuator assembly 10 and 12 corresponds in size generally to the back face 64 of the cup 50 which it backs. The two piezoelectric actuator assemblies 10 and 12 each have the capacity to expand and contract in at least an axial direction, and thereby axially displace the two cups 50 in their respective counterbores 36 and 40.

Each piezoelectric actuator assembly 10 and 12 comprises a series of plates 70 arranged face to face to create a stack, and associated electrical leads 72 extending from the stack for connection across an electrical potential of variable voltage. Each plate 70 is formed from a piezoelectric ceramic, and the individual plates 70 are each connected to the leads 72 such that each may be placed across an electrical potential. Each plate 70 produces an electrical potential when compressed, and conversely when an electrical potential is impressed across it, it expands in at least an axial dimension. Typically a single plate 70 is about 0.0035 in. thick. When electrical potential is impressed across the plate 70, the plate 70 will expand axially about 5 μin. Potentials of a lesser magnitude produce less expansion. Therefore, a stack composed of 200 plates 70 will occupy about 0.7 in (200×0.0035 in) and at the most will expand about 0.001 in. (200×5 μin.) when the maximum electrical potential is impressed across each plate 70. The two piezoelectric actuator assemblies 10 and 12 together occupy about 1.4 in. and expand a maximum of 0.002 in. When expanding, each piezoelectric actuator assembly 10 and 12 is capable of producing a force on the order of 1000 lbs.

The piezoelectric actuator assembly 10 fits snugly between associated cup 50 and the shoulder 38 for the counterbore 36 in which the piezoelectric actuator assembly 10 is confined, and likewise the piezoelectric actuator assembly 12 fits snugly between associated cup 50 and the shoulder 42 of the counterbore 40 in which the piezoelectric actuator assembly 12 is located. This is achieved by turning the nut 30 down against the collar 28 while the rollers 52 of the head bearing 6 are seated against the raceway 56 and 62 of that bearing, so no clearances exist in the bearing 6. As the collar 28 advances over the shaft 2, the collar 28 drives the cone 48 of the tail bearing 8 over associated seat 24 on the shaft 2. The advance terminates when the bearings 6 and 8 achieve the correct setting, which typically is zero end play and preload.

The initial setting established by the nut 30 may provide enough stability for most operating conditions under which the shaft 2 rotates. However, certain conditions may require greater stiffness. When the shaft 2 experiences those conditions, an electrical potential is impressed across each piezoelectric actuator assembly 10 and 12—actually across each plate 70—and the piezoelectric actuator assemblies 10 and 12 expand axially. Each piezoelectric actuator assembly 10 and 12 bears against the back faces 64 of the cups 50 for the two bearings 6 and 8 and drive the cups 50 apart. This imparts preload to the bearings 6 and 8, with the magnitude of the preload depending on the magnitude of the electrical potential, up to a maximum expansion of each piezoelectric actuator assembly 10 and 12.

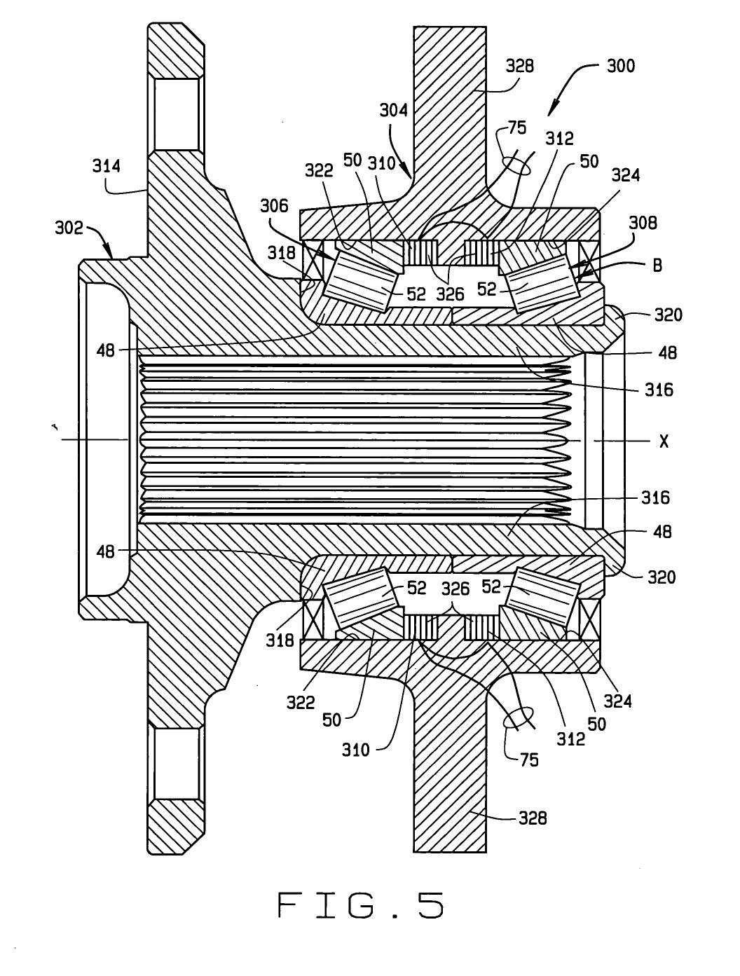

Preferably, the electrical potential impressed across each piezoelectric actuator assembly 10 and 12 from a power source 50 is regulated by a control circuit 100, shown in FIG. 4. When the piezoelectric actuator assemblies 10 and 12 are not energized, the control circuit 100 is configured such that each piezoelectric actuator assembly 10 and 12 is electrically connected across a resistor element 102. The resistor element 102 prevents each piezoelectric actuator assembly 10 and 12 from establishing an open electrical circuit, potentially resulting in excessive induced voltages in each piezoelectric actuator assembly 10 and 12 under a compressive force in the bearing system. Excessive induced voltages which could damage the plates 70 comprising each piezoelectric actuator assembly 10 and 12.

Control circuit 100 is preferably configured in the form of a closed loop control system utilizing a parameter associated with each piezoelectric actuator assembly 10 and 12, and may be displaced from the physical location of the bearing system A, as required for each particular application, when suitable electrical connectors 75 to each piezoelectric actuator assembly 10 and 12 are provided.

In a first embodiment, each piezoelectric actuator assembly 10 and 12 is utilized as a resonance device (i.e., a tank circuit) in a standard oscillator circuit (e.g. Colpitts, Pierce, etc.). Selected resonant frequencies of each piezoelectric actuator assembly 10 and 12 provide a measure of a characteristic of the piezoelectric actuator assembly 10 and 12, from which a elongation information for each piezoelectric actuator assembly 10 and 12 from an initial or desired state can be determined by a suitable comparator 104, such as a microprocessor or other logic circuit having sufficient computational capacity. These resonance frequencies typically have much higher frequencies than the structure within which each piezoelectric actuator assembly 10 and 12 is disposed. The comparator 104 is configured in a responsive manner to regulate the electrical potential from the power source 105 impressed on each piezoelectric actuator assembly 10 and 12 to achieve the desired bearing setting.

In an exemplary embodiment, an excitation voltage is applied to piezoelectric actuator assembly 10, 12 to obtain an indication of length. One half of the piezoelectric actuator assembly 10, 12 is supplied with an excitation voltage which is 180° out-of-phase with respect to the excitation voltage supplied to the remaining half. This produces a sinusoidal node shape in the resonance, with nodes in the middle and at each end. Hence one wavelength of this since wave is equivalent to the length of the piezoelectric actuator assembly 10, 12. Since the patterned excitation voltage is of a significantly higher frequency than the larger operating voltage for each piezoelectric actuator assembly 10, 12, it may be superimposed on top of the larger operating voltage.

Optionally, when utilizing the piezoelectric actuator assembly 10 and 12 as a resonance device, a temperature sensor 106 may be operatively disposed to acquire thermal measurements for each piezoelectric actuator assembly 10 and 12. Thermal measurements supplied to the comparator 104 may then be utilized to compensate for thermal effects on the resonant frequencies.

In an alternate embodiment, a sensor 108, such as a pressure gauge, a strain gauge, or a stress gauge, is disposed to provide a measure of a force exerted at a piezoelectric actuator assembly 10 and 12. A signal representative of the measured force is provided to the control circuit 10. The comparator 104 compares the measured force to an initial or desired state for each piezoelectric actuator assembly 10 and 12, and correspondingly regulates the electrical potential from the power source 105 impressed on each piezoelectric actuator assembly 10 and 12 to achieve the desired bearing setting.

In an alternate embodiment, a displacement sensor 110, such as a capacitive sensor, LVDT, or strain gauge, is disposed to provide a measure of a displacement of each piezoelectric actuator assembly 10 and 12 from an initial state. A signal representative of the measured displacement is provided to the control circuit 10. The comparator 104 compares the measured displacement to an initial or desired state for each piezoelectric actuator assembly 10 and 12, and correspondingly regulates the electrical potential from the power source 105 impressed on each piezoelectric actuator assembly 10 and 12 to achieve the desired bearing setting.

As shown in FIG. 4, during operation, the control system 100 preferably functions as a closed loop control for the piezoelectric actuator assemblies 10 and 12. An initial measurement of a piezoelectric actuator assembly parameter, such as displacement, resonance, or pressure, is obtained (Box 200). The initial measurement is compared with either desired setting for each piezoelectric actuator assembly 10 and 12, or a desired bearing setting to determine if a change is required in the axial displacement of each piezoelectric actuator assembly 10 and 12 (Box 202). If no change is required, i.e. the bearing setting is at a desired level, the process of measuring and comparing is repeated. If a change is required to alter a desired setting, the electrical potential impressed across one or both of the piezoelectric actuator assemblies 10 and 12 is altered to alter at least an axial dimension of the piezoelectric actuator assemblies 10 and 12, thereby altering the bearing setting (Box 204). Following the alteration of the impressed electrical potential, the process of measurement and comparison is repeated, establishing a closed loop feedback system.

Turning to FIG. 5, a modified bearing system B, is shown suitable for a wheel end 300 of an automotive vehicle where it enables a wheel hub 302 to rotate in a housing 304 that is secured to a suspension system component of the automotive vehicle. The bearing system B, like the system A, has outboard and inboard bearings 306 and 308 and piezoelectric actuator assemblies 310 and 312, composed of stacked annular plates (not shown).

The hub 302 has a flange 314, to which the rim of a road wheel is attached, and a spindle 316 which projects from the flange 314, it leading away from a shoulder 318 and terminating at a formed end 320 or other device for capturing the bearings 306 and 308 on the spindle 316. The housing 304 contains two bearing seats 322 and 324 in the form of counterbores that lead away from shoulders 326. It also has a flange 328 which is fastened to the suspension system component.

The bearing 306 and 308, each have a cone 48, a cup 50, and tapered rollers 52, which basically correspond to the counterparts in the bearings 6 and 8, although the cones 48 have extensions that abut. The cones 48 fit over the spindle 316 with interference fits, the back face 64 of the cone 48 for the outboard bearing 308 being against the shoulder 318 and the back face 64 of the cone 48 for the inboard bearing 308 being against formed end 320. The cup 50 for the outboard bearing 306 and the piezoelectric actuator assembly 310 fits into the bearing seat 322 of the housing 304, with the piezoelectric actuator assembly 310 being interposed between the shoulder 326 for that seat and the back face 64 of the cup 50. The cup 50 for the inboard bearing 308 and the piezoelectric actuator assembly 312 fits into the other bearing seat 324, with the piezoelectric actuator assembly 312 being interposed between the shoulder 326 of that seat and the back face 64 of the cup 50. The cups 50 fit loosely in their respective seats 322 and 324, and the piezoelectric actuator assemblies 310 and 312 expand and contract to displace the cups 50 axially and thereby control the setting of the bearings 306 and 308.

Variations are possible. For example, a bearing system may adjust its setting through the positioning of the cones 48, in which event the piezoelectric actuators would be behind the back faces 60 of the cones 48. Also, a single actuator located behind the back face 64 of only one of the cups 50 or behind the back face 60 of only one of the cones 48 will suffice. Apart from that, actuators similar to the piezoelectric actuator assemblies 10, 12, 310 and 312 may be installed behind the back faces 64 of cups 50 or the back faces 60 of cones 48 in systems having directly mounted bearings, that is to say bearings in which the large ends of the rollers 52 for the two bearings are presented toward each other. Moreover, piezoelectric actuator assemblies similar to the piezoelectric actuator assemblies 10, 12, 310 and 312 may be utilized with bearing systems having other types of bearings that have inclined raceways which enable them to accommodate both axial loads and radial loads, angular contact ball bearings and spherical roller bearings, for example. In any of the bearing systems, the races that do not displace may be formed integral with the components on which they are positioned, in which event the raceways are formed directly on those components. Furthermore any race that undergoes displacement may be subjected to a force exerted by a spring, with that force seeking to seat the rolling elements against their raceways, and may be resisted by a piezoelectric actuator assembly, so the piezoelectric actuator assembly still controls the position of the displaceable race.

What is claimed is:

1. A bearing system located between inner and outer machine components for enabling one of the machine components to rotate relative to the other machine component about an axis of rotation, said system comprising:
first inner and outer raceways carried by the inner and outer machine components, respectively, said first inner and outer raceways being inclined in a first common direction with respect to the axis;
second inner and outer raceways carried by the inner and outer machine components, respectively, said second inner and outer raceways being inclined in a second common direction with respect to the axis, said second common direction opposite to said first common direction;
first rolling elements arranged in a row between said first raceways to form a first bearing and second rolling elements arranged in a row between said second raceways to form a second bearing;
a first race fitted to one of the machine components, said first race being configured to move axially on said machine component, said first race including one of said first raceways and forming part of said first bearing, said first race further including a back face presented toward a shoulder on the machine component to which said first race is fitted; and
a piezoelectric actuator assembly disposed between said back face of said first race and said shoulder, whereby a setting of at least said first bearing may be altered by varying an electrical potential impressed across said piezoelectric actuator assembly.

2. A bearing system according to claim 1 wherein said piezoelectric actuator assembly comprises a plurality of piezoelectric plates organized face to face.

3. A bearing system according to claim 1 wherein a second race is fitted to said one machine component, said second race including one of the second raceways, said second race having a back face presented toward a second shoulder in said one machine component; and
a second piezoelectric actuator assembly disposed between said back face of said second race and said second shoulder.

4. A bearing system according to claim 1 wherein said raceways lie within substantially conical envelopes and said rolling elements are tapered rollers.

5. The bearing system of claim 1 further including a control circuit operatively coupled to said piezoelectric actuator assembly, said control circuit configured to regulate said electrical potential impressed across said piezoelectric actuator assembly.

6. The bearing system of claim 5 wherein said control circuit further includes a frequency locking circuit, said frequency locking circuit configured to measure a resonance of said piezoelectric actuator assembly, said resonance representative of a characteristic of the piezoelectric actuator assembly related to an axial dimension of said piezoelectric actuator assembly; and
wherein said control circuit is further configured to regulate said electrical potential impressed across said piezoelectric actuator assembly responsive to said measured resonance.

7. The bearing system of claim 6 further including a temperature sensor configured to output a signal representative of a temperature of said piezoelectric actuator assembly; and
wherein said control circuit is further configured to receive said temperature signal and to compensate said measure of resonance for thermal effects.

8. The bearing system of claim 5 further including a sensor configured to output a signal representative of a force on said piezoelectric actuator assembly; and
wherein said control circuit is further configured to receive said force signal and to regulate said electrical potential impressed across said piezoelectric actuator assembly responsive to said force signal.

9. A machine comprising:
an inner component located along an axis;
an outer component located coaxial with said inner component;
a first antifriction bearing located between said inner component and said outer component to facilitate rotation of one of said components relative to the other component about said axis, said first antifriction bearing configured to transfer thrust loads in a first axial direction between said components, as well as radial loads between said components;
a second antifriction bearing located between said inner component and said outer component to facilitate rotation of one of said components relative to the other component about said axis, said second antifriction bearing configured to transfer thrust loads in a second axial direction between said components, as well as radial loads between said components;
first and second raceways disposed on said second antifriction bearing, each of said raceways inclined in a common direction with respect to said axis;
rolling elements arranged in a single row between each of said raceways, said first raceway fixed in position with respect to one of said components, said second raceway being on a race carried by the other component, with said axially displaceable on said other component; and
at least one piezoelectric actuator disposed to change a setting of said antifriction bearings.

10. A machine according to claim 9 wherein said at least one piezoelectric actuator is disposed between said race of said second antifriction bearing and said other component in which said second antifriction bearing race is located for displacing said second antifriction bearing race axially when energized.

11. A machine according to claim 9 wherein said at least one piezoelectric actuator is disposed such that when energized, said piezoelectric actuator causes said rolling elements to seek a more fully seated condition between said raceways.

12. A machine according to claim 11 wherein the first antifriction bearing includes third and fourth raceways which are carried by said components, said third and fourth raceways inclined in a second common direction, which direction is opposite the common direction of said first and second raceways;
rolling elements arranged in a single row between said third and fourth raceways.

13. A machine according to claim 12 wherein each of said raceways of said first and second bearings lie within substantially conical envelopes, and said rolling elements are tapered rollers.

14. A bearing according to claim 9 wherein said race has a back face through which thrust loads are transferred between said race and said other component in which said race is located; and
wherein said at least one piezoelectric actuator is disposed to bear against said back face.

15. The bearing system of claim 9 further including a control circuit operatively coupled to said at least one piezoelectric actuator assembly, said control circuit configured to regulate an electrical potential impressed across said at least one piezoelectric actuator assembly, said at least one piezoelectric actuator altering at least an axial dimension responsive to an impressed electrical potential.

16. The bearing system of claim 15 wherein said control circuit further includes a frequency locking circuit, said frequency locking circuit configured to measure a resonance of said at least one piezoelectric actuator assembly, said resonance representative of a characteristic of said at least one piezoelectric actuator assembly related to an axial dimension of said at least one piezoelectric actuator assembly; and
wherein said control circuit is further configured to regulate said electrical potential impressed across said at least one piezoelectric actuator assembly responsive to said measured resonance.

17. The bearing system of claim 16 further including a temperature sensor configured to output a signal representative of a temperature of said at least one piezoelectric actuator assembly; and
wherein said control circuit is further configured to receive said temperature signal and to compensate said measure of resonance for thermal effects.

18. The bearing system of claim 15 further including a sensor configured to output a signal representative of a force on said at least one piezoelectric actuator assembly; and
wherein said control circuit is further configured to receive said force signal and to regulate said electrical potential impressed across said at least one piezoelectric actuator assembly responsive to said force signal.

19. In combination with first and second machine components, a bearing system for enabling the one of the components to rotate relative to the other component about an axis of rotation, said bearing system comprising:
a first antifriction bearing located between the first and second machine components, said first antifriction bearing being capable of transferring radial and axial loads between the first and second machine components;
a second antifriction bearing located between the first and second machine components, said second antifriction bearing being capable of transferring axial and radial loads between the first and second machine components; and
at least one piezoelectric actuator disposed to control said setting of the first and second antifriction bearings.

20. The combination according to claim 19 wherein the first antifriction bearing transfers axial loads in a first axial direction and the second bearing transfers axial loads in a second and opposite axial direction.

21. The combination according to claim 19 wherein said second antifriction bearing includes a race configured for axial displacement within one of the first and second machine components to change the setting of said first and second antifriction bearings; and
wherein said at least one piezoelectric actuator is disposed between said race and the machine component in which said race is located to control axial displacement of said race and said setting of the first and second antifriction bearings.

22. The combination according to claim 20 wherein each antifriction bearing includes an inner raceway presented away from the axis and an outer raceway presented toward the axis and toward the inner raceway, with one of the raceways for the second bearing being on said displaceable race; and wherein each antifriction bearing further includes rolling elements located between associated inner and outer raceways.

23. The combination according to claim 22 wherein said rolling elements of each antifriction bearing are arranged in a single row between said raceways of said antifriction bearings.

24. The combination according to claim 22 wherein said raceways of each antifriction bearing are inclined with respect to the axis, with an inclination of said raceways for said first antifriction bearing being opposite to an inclination of said raceways for said second antifriction bearing, so that said first antifriction bearing will transfer axial loads in one axial direction and said second antifriction bearing will transfer axial loads in an opposite axial direction.

25. The combination according to claim 24 wherein the first machine component rotates and the second machine component is fixed against rotation; and wherein said displaceable race is on the first machine component;

26. The combination according to claim 24 wherein said raceways lie in generally conical envelopes and said rolling elements are tapered rollers.

27. The combination according to claim 20 wherein said first antifriction bearing also has a race configured for axial displacement within said one component, to contribute to the change in setting for the bearings; and
wherein a second piezoelectric actuator is located between said one component and said first bearing displaceable race.

28. The bearing system of claim 19 further including a control circuit operatively coupled to said at least one piezoelectric actuator assembly, said control circuit configured to regulate an electrical potential impressed across said at least one piezoelectric actuator assembly, said at least one piezoelectric actuator altering at least an axial dimension responsive to an impressed electrical potential.

29. The bearing system of claim 28 wherein said control circuit further includes a frequency locking circuit, said frequency locking circuit configured to measure a resonance of said at least one piezoelectric actuator assembly, said resonance representative of a characteristic of said at least one piezoelectric actuator assembly related to an axial dimension of said at least one piezoelectric actuator assembly; and
wherein said control circuit is further configured to regulate said electrical potential impressed across said at least one piezoelectric actuator assembly responsive to said measured resonance.

30. The bearing system of claim 29 further including a temperature sensor configured to output a signal representative of a temperature of said at least one piezoelectric actuator assembly; and
wherein said control circuit is further configured to receive said temperature signal and to compensate said measure of resonance for thermal effects.

31. The bearing system of claim 28 further including a sensor configured to output a signal representative of a force on said at least one piezoelectric actuator assembly; and
wherein said control circuit is further configured to receive said force signal and to regulate said electrical potential impressed across said at least one piezoelectric actuator assembly responsive to said force signal.

32. A process for controlling the setting of a pair of antifriction bearings mounted in opposition between first and second machine components, one of which is located within the other, with at least one of the bearings having a race that displaces axially with respect to the first machine component, said process comprising:
varying the axial position of said one race with a piezoelectric actuator disposed between the displaceable race and the first machine component.

33. The process of claim 32 for controlling the setting of a pair of antifriction bearings further including:
monitoring an axial dimension of said piezoelectric actuator; and
controlling an electrical potential impressed on said piezoelectric actuator responsive to said axial dimension.

34. A process for controlling the setting of a pair of antifriction bearings mounted in opposition between first and coaxial second machine components, at least one of the bearings having a race that displaces axially with respect to the first machine component, and at least one piezoelectric actuator disposed between the displaceable race and the first machine component, comprising:
controlling an electrical potential impressed across the at least one piezoelectric actuator, said piezoelectric actuator varying in at least an axial dimension responsive to said controlled electrical potential to axially displace the bearing race.

35. The process of claim 34 for controlling the setting of a pair of antifriction bearings further including:
determining an axial dimension of the at least one piezoelectric actuator; and
wherein said electrical potential impressed across the at least one piezoelectric actuator is controlled responsive to said determined axial dimension.

36. The process of claim 35 for controlling the setting of a pair of antifriction bearings wherein said step of determining includes measuring the resonance of the at least one piezoelectric actuator, said measured resonance representative of a characteristic of said at least one piezoelectric actuator which is related to said axial dimension of the at least one piezoelectric actuator.

37. The process of claim 36 for controlling the setting of a pair of antifriction bearings further including the step of measuring a temperature of the at least one piezoelectric actuator; and
wherein said step of determining includes compensating said measured resonance for thermal effects responsive to said measured temperature.

38. The process of claim 34 for controlling the setting of a pair of antifriction bearings further including:
measuring a force exerted on the bearing race by the at least one piezoelectric actuator; and
wherein said electrical potential impressed across the at least one piezoelectric actuator is controlled responsive to said measured force.

39. A bearing system having an inner race including an inner raceway, an outer race having an outer raceway, a plurality of rolling elements arranged in a row between the inner and outer raceways, and the inner and outer raceways each carried by an associated supported component and inclined in a common direction with respect to a common axis, comprising:
a piezoelectric actuator assembly disposed between one of the inner and outer races and an associated supported component, whereby a setting of the bearing system may be altered by varying an electrical potential impressed across said piezoelectric actuator assembly.

40. The bearing system of claim 39 wherein said setting is an axial relationship between the inner and outer races.

41. The bearing system of claim 39 wherein said piezoelectric actuator assembly includes a plurality of annular piezoelectric elements in a stacked configuration.

42. The bearing system of claim 39 further including a control circuit operatively coupled to said piezoelectric actuator assembly, said control circuit configured to regulate said electrical potential impressed across said piezoelectric actuator assembly.

43. The bearing system of claim 42 wherein said control circuit further includes a frequency locking circuit, said frequency locking circuit configured to measure a resonance of said piezoelectric actuator assembly, said resonance representative of a characteristic of said piezoelectric actuator assembly related to an axial dimension of said piezoelectric actuator assembly; and
wherein said control circuit is further configured to regulate said electrical potential impressed across said piezoelectric actuator assembly responsive to said measured resonance.

44. The bearing system of claim 43 further including a temperature sensor configured to output a signal representative of a temperature of said piezoelectric actuator assembly; and
wherein said control circuit is further configured to receive said temperature signal and to compensate said measure of resonance for thermal effects.

45. The bearing system of claim 42 further including a sensor configured to output a signal representative of a force on said piezoelectric actuator assembly; and
wherein said control circuit is further configured to receive said force signal and to regulate said electrical potential impressed across said piezoelectric actuator assembly responsive to said force signal.
